(19) United States
(12) Patent Application Publication
(10) Pub. No.: US 2006/0203484 A1
(43) Pub. Date: Sep. 14, 2006

(54) LIGHT EMITTING DIODE, LIGHT EMITTING DIODE MODULE, AND RELATED BACKLIGHT SYSTEM

(76) Inventor: Tai-Cherng Yu, Shenzhen (CN)

Correspondence Address: NORTH AMERICA INTELLECTUAL PROPERTY CORPORATION, P.O. BOX 506, MERRIFIELD, VA, 22116, US

(21) Appl. No.: 11/308,156

(22) Filed: Mar. 9, 2006

(30) Foreign Application Priority Data
Mar. 11, 2005 (CN) 200510033619.3

(51) Int. Cl. F21V 9/00

(52) U.S. Cl. 362/231

(57) ABSTRACT

A backlight system (100) includes a reflecting frame (50) with a reflecting bottom (53) and a reflecting sidewall (52) defining an opening, a diffusing sheet (60) and a prism sheet (70) located at the opening of the reflecting frame in that order, and an array of light emitting diode modules (51) regularly disposed on the reflecting bottom. The light emitting diode module includes a number of red, green, and blue light emitting diodes (30) regularly arranged to obtain a white light. Each of the light emitting diodes includes a substrate (31), a light emitting diode chip (32) arranged on and electrically connecting with the substrate, and a conical transparent cover (33) arranged on the substrate and surrounding the light emitting diode chip. A number of microstructures (333) is formed on an inner surface of the transparent cover.

### FIELD OF THE INVENTION

The present invention relates to light emitting diodes (LEDs), LED modules using the LEDs, and backlight systems using the LED modules and, more particularly, to LEDs with high-purity white light and uniform luminance.

### DESCRIPTION OF RELATED ART

Backlight system is an important component of a liquid crystal display (LCD) device, and its function is to provide a planar light for illuminating an LCD panel of the LCD device. Desirable performances of the backlight system used in the LCD device generally include high luminance, adjustable chromaticity and color temperature, low power consumption, and long lifespan, etc.

Referring to FIG. 9, a conventional backlight system 10 includes a reflecting frame 11 with an opening, a plurality of cold cathode fluorescent lamps (CCFLs) 12 regularly disposed in the reflecting frame 11 in a juxtaposed manner shown in FIG. 10, and a diffusing plate 13 located at the opening of the reflecting frame 11. In addition, a diffusing sheet 14, a prism sheet 15, and a dual luminance enhancement film (DBEF) 16 are arranged on the diffusing plate 13 in that order. Thus, a proximately uniform light with high luminance can be created by the backlight system 10.

However, the CCFL 12 used as initial light source of the backlight system 10 has large power consumption, and uniformity of luminance and purity of white light thereof are not excellent. In addition, because the CCFL 12 is expensive, the use of the CCFL 12 increases the cost of the backlight system 10. The backlight system 10 utilizing the CCFL 12 cannot satisfy high level requirements of the developing LCD device any more.

For above reasons, LED with high luminance, low power consumption, and long lifespan has been adopted as light source of the backlight system used in the LCD device. The LEDs, which can directly emit white light, are disclosed in U.S. Pat. Nos. 6,614,179 and 6,686,691. However, this type of white LED has a fixed spectrum, and the color temperature thereof is also invariable, which is undesirable.

Now, an LED module of red (R) LED, green (G) LED, and blue (B) LED has been developed in order to substitute the CCFL as light source of the backlight system. These R LED, G LED, and B LED can mix their respective color light into a white light. Referring to FIG. 11, a conventional backlight system 20 utilizing the LED module is shown. The backlight system 20 includes a reflecting frame 21 with an opening, an array of LED modules 22 regularly disposed in the reflecting frame 21 in an array manner shown in FIG. 12, and a diffusing plate 23 located at the opening of the reflecting frame 21. In addition, a diffusing sheet 24, a prism sheet 25, and a DBEF 26 are arranged on the diffusing plate 23 in that order. Each of the LED modules 22 is composed of an array of R, G, and B LEDs 220 shown in FIG. 13. Thus, the color temperature of the backlight system 20 can be adjusted by known method, and satisfy different requirements.

However, referring to FIGS. 14 to 15, because the LED 220 is generally constructed by a substrate 221, an LED chip 222 disposed on the substrate 221, and an optical glass 223 covering the LED chip 222. The optical glass 223 generally tends to converge lights emitted from the LED chip 222, which results in an uneven distribution of the luminance. That is, the center portion of the LED 220 emits a bright light, while the edge portion of the LED 220 emits a dim light. Under this situation, the LCD device using the LED 220 still cannot achieve an excellent display quality.

What are needed, therefore, are an LED with high-purity white light and uniform luminance, an LED module using the LED, and a backlight system using the LED module.

### SUMMARY OF INVENTION

An LED according to one preferred embodiment includes a substrate, an LED chip arranged on and electrically connecting with the substrate, and a conical transparent cover arranged on the substrate and surrounding the LED chip. The cover has an inner surface and a stepped structure formed on the inner surface thereof.

An LED module according to one preferred embodiment includes at least a red LED, at least a green LED, and at least a blue LED. The red, green and blue LEDs are arranged for providing a white light illuminance. Each of the red, green, and blue LEDs includes a substrate, an LED chip arranged on and electrically connecting with the substrate, and a conical transparent cover arranged on the substrate and surrounding the LED chip. The cover has an inner surface and a stepped structure formed on the inner surface thereof.

A backlight system according to one preferred embodiment includes a reflecting frame having a reflecting bottom, and an array of LED modules regularly disposed on the reflecting bottom. The LED module includes at least a red LED, at least a green LED, and at least a blue LED. The red, green and blue LEDs are arranged for providing a white light illuminance. Each of the red, green, and blue LEDs includes a substrate, an LED chip arranged on and electrically connecting with the substrate, and a conical transparent cover arranged on the substrate and surrounding the LED chip. The cover has an inner surface and a stepped structure formed on the inner surface thereof.

Compared with conventional LED, the present LED has following advantages. When light is emitted from the LED chip, the transparent cover can scatter the light. That is, the initially bright light in the center portion of the LED is decreased, and the initially dim light in the edge portion of the LED is increased. Thus, a more uniform luminance of the light at each radiation angle is achieved. The present LED module can create a white light with high purity and uniform luminance. Because the white light is formed by mixed R light, G light, and B light, the color temperature of the present LED module can be adjusted and satisfy different requirements. The present backlight system can create a uniformly planar white light for illuminating an LCD panel of an LCD device.

Other advantages and novel features will become more apparent from the following detailed description of present LED, LED module, and related backlight system, when taken in conjunction with the accompanying drawings.

### BRIEF DESCRIPTION OF DRAWINGS

Many aspects of the present LED, LED module, and related backlight system can be better understood with reference to the following drawings. The components in the drawings are not necessarily to scale, the emphasis instead being placed upon clearly illustrating the principles of the present LED, LED module, and related backlight system. Moreover, in the drawings, like reference numerals designate corresponding parts throughout the several views.

FIG. 1 is a perspective, schematic view of an LED in accordance with a first embodiment;

FIG. 2 is a schematic, cross-sectional view of the LED of FIG. 1, taken along line II-II thereof;

FIG. 3 is a luminance distribution of the light emitted by the LED of FIG. 1;

FIG. 4 is a schematic view of an LED module in accordance with a second embodiment;

FIG. 5 is a schematic view of an LED module in accordance with a third embodiment;

FIG. 6 is a schematic view of an LED module in accordance with a fourth embodiment;

FIG. 7 is a schematic, side view of a backlight system in accordance with a fifth embodiment;

FIG. 8 is a schematic, top view of the backlight system of FIG. 7;

FIG. 9 is a schematic, side view of a first conventional backlight system utilizing CCFLs as a light source;

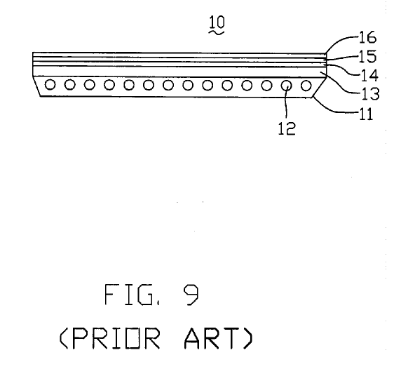

FIG. 10 is a schematic, top view of the backlight system of FIG. 9;

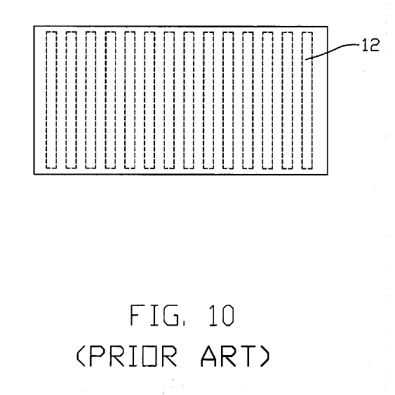

FIG. 11 is a schematic, side view of a second conventional backlight system utilizing LEDs as a light source;

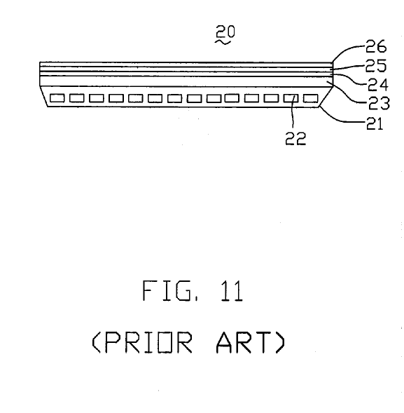

FIG. 12 is a schematic, top view of the backlight system of FIG. 11;

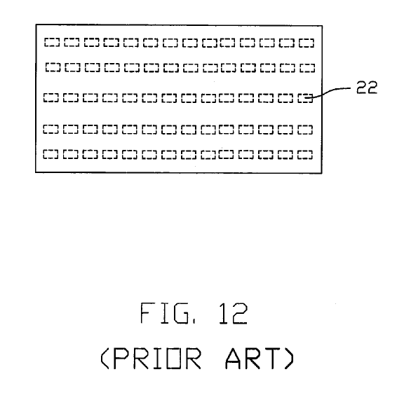

FIG. 13 is a schematic, isometric view of an LED used in the backlight system of FIG. 11;

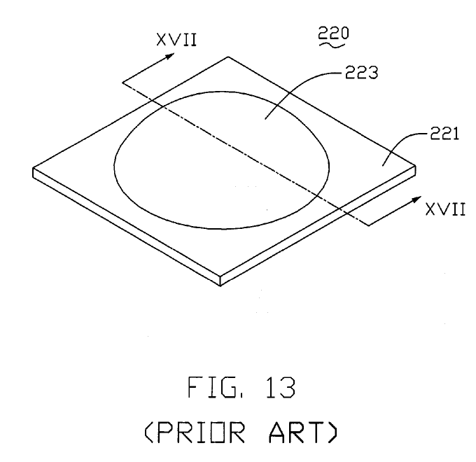

FIG. 14 is a schematic, cross-sectional view of the LED of FIG. 13, taken along line XVII-XVII thereof; and

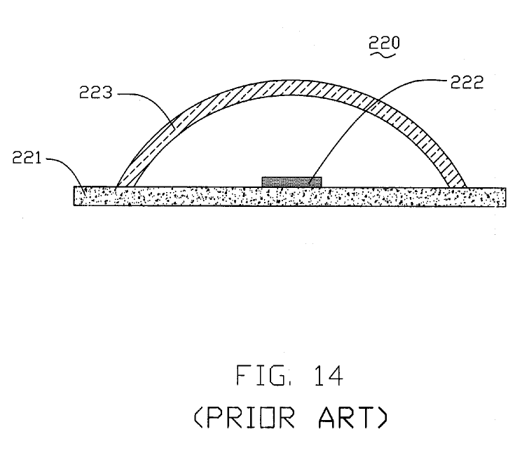

FIG. 15 is a luminance distribution of the light emitted by the LED of FIG. 13.

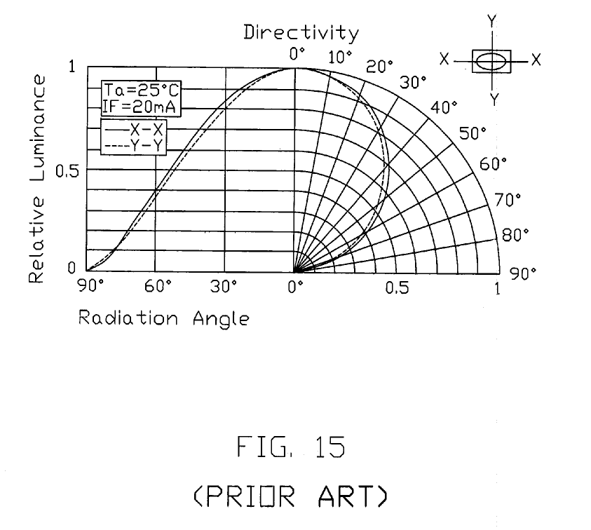

### DETAILED DESCRIPTION

Reference will now be made to the drawings to describe preferred embodiments of the present LED, LED module, and related backlight system, in detail.

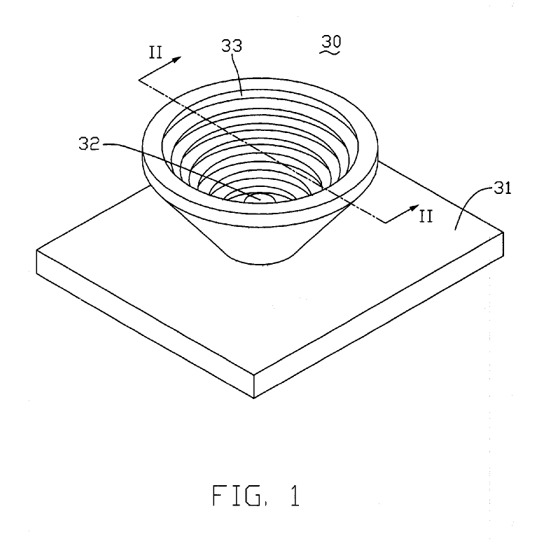

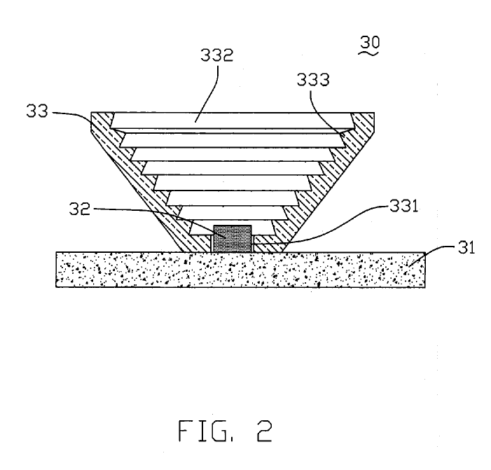

Referring to FIGS. 1 to 2, an LED 30, in accordance with a first embodiment, is shown. The LED 30 includes a substrate 31, an LED chip 32 arranged on the substrate 31, and a conical glass cover 33 arranged on the substrate 31 and surrounding the LED chip 32.

The LED chip 32 electrically connects with the substrate 31, and can emit red light, green light, or blue light when being powered. The glass cover 33 includes a first end defining a first opening 331 and an opposing second end defining a second opening 332 larger than the first opening 331. A hollow passage is defined in the glass cover 33. The first end of the glass cover 33 is connected with the substrate 31. The LED chip 32 is located in the first opening 331. Preferably, the LED chip 32 is located in a center portion of the first opening 331. The glass cover 33 includes an outer surface and an inner surface. The outer surface is generally a conical surface. A stepped structure 333 is formed on the inner surface of the glass cover 33.

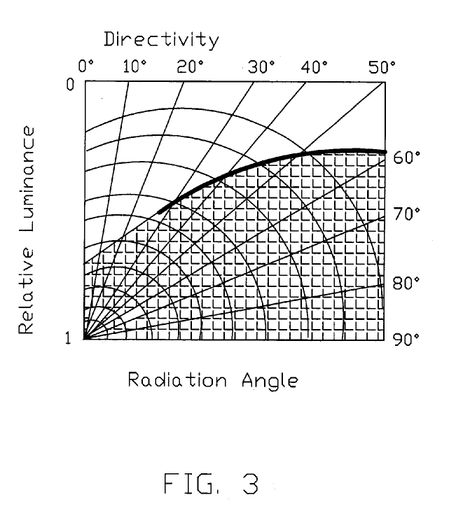

When light is emitted from the LED chip 32, the glass cover 33 can scatter the light. That is, the initially bright light in the center portion of the LED 30 is decreased, and the initially dim light in the edge portion of the LED 30 is increased. Thus, a more uniform luminance of the light at each radiation angle is achieved (referring to FIG. 3).

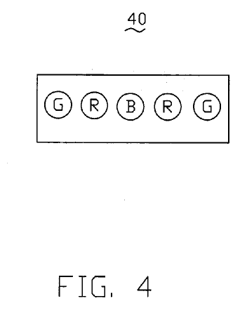

Referring to FIG. 4, an LED module 40, in accordance with a second embodiment, is shown. The LED module 40 includes two R LEDs, two G LEDs, and a B LED. These LEDs are configured to be similar to or identical with the above-mentioned LEDs 30 of the first embodiment. These LEDs are arranged in a line in an order of G-R-B-R-G thereby obtain a satisfactory white light mixed by R light, G light, and B light. Preferably, the power proportion of the G LED, the R LED and the B LED is equal to 1:1:0.18, and a center-to-center distance of two adjacent LEDs is about 9 mm.

Alternatively, the configuration of the LED module 40 can be changed according to different requirements, such as the LEDs of the LED module can be arranged in a linear order selected from the group consisting of R-G-B, G-R-B-G, R-G-B-G-R, G-R-B-B-R-G, R-G-R-B-B-G-R, G-R-B-G-G-B-R-G, and G-R-B-B-R-G-G-R-B. In these alternative arrangements of the LEDs, the power proportion of the LEDs is decided according to the desirable white point, and the center-to-center distance between adjacent LEDs preferably is about 9 mm.

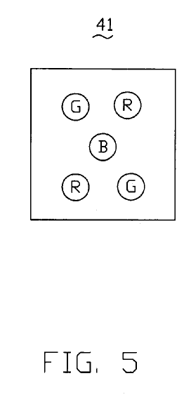

The LEDs can also be arranged in a curved, staggered or circular fashion. Referring to FIG. 5, an LED module 41, in accordance with a third embodiment, is shown. The LED module 41 includes four LEDs arranged in a staggered fashion in a circular order of G-R-G-R, and a B LED located in the center of the four LEDs.

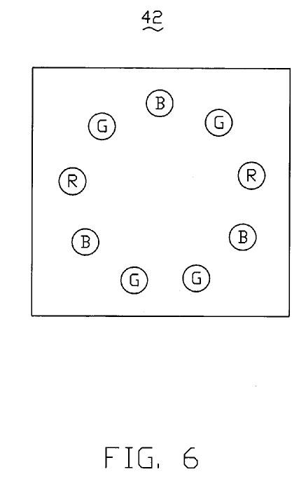

Referring to FIG. 6, an LED module 42, in accordance with a fourth embodiment, is shown. The LED module 42 includes nine LEDs arranged in a circular fashion in an order of B-G-R-B-G-G-B-R-G.

Because each LED of the LED module has uniform luminance, these R LED, G LED and B LED can fully mix their respective color light into a white light. Thus, a white light with high purity and uniform luminance can be achieved. Particularly, the chromaticity coordinate of the white light can be (x=0.35, y=0.38). In addition, because the white light is formed by mixed R light, G light, and B light, the color temperature of the LED module can be adjusted by known method, and satisfy different requirements.

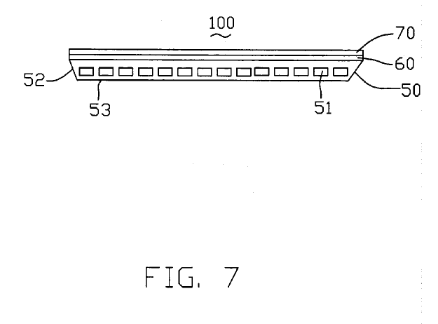

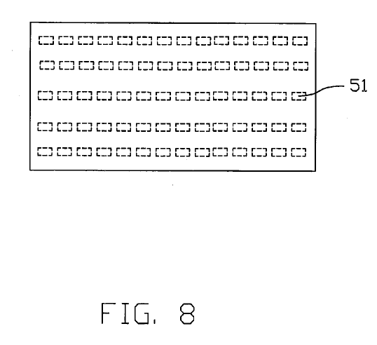

Referring to FIG. 7, a backlight system 100, in accordance with a fifth embodiment, is shown. The backlight system 100 includes a reflecting frame 50 with a reflecting bottom 53 and a reflecting sidewall 52, an array of LED modules 51 regularly disposed on the reflecting bottom 53 in a manner shown in FIG. 8, and a diffusing sheet 60 located at an opening of the reflecting frame 50 defined by the sidewall 52. The LED module 51 is configured to be similar to or identical with the foregoing LED modules 40, 41, 42. In addition, a prism sheet 70 is arranged on the diffusing sheet 60. A DBEF can also be arranged on the prism sheet 70 to further increase the luminance of the backlight system 100. Thus, a uniformly planar white light for illuminating an LCD panel of an LCD device is achieved.

It is to be understood that the above-described embodiment is intended to illustrate rather than limit the invention. Variations may be made to the embodiment without departing from the spirit of the invention as claimed. The above-described embodiments are intended to illustrate the scope of the invention and not restrict the scope of the invention.

What is claimed is:

1. A light emitting diode, comprising:
a substrate;
a light emitting diode chip arranged on and electrically connecting with the substrate; and
a conical transparent cover arranged on the substrate and surrounding the light emitting diode chip, the cover having an inner surface and a stepped structure formed on the inner surface thereof.

2. The light emitting diode as claimed in claim 1, wherein the cover comprises a first end defining a first opening and an opposing second end defining a second opening larger than the first opening, the first end being connected with the substrate.

3. The light emitting diode as claimed in claim 1, wherein an outer surface of the cover is conical.

4. The light emitting diode as claimed in claim 2, wherein the light emitting diode chip is located in a center portion of the first opening.

5. A light emitting diode module, comprising:
at least a red light emitting diode;
at least a green light emitting diode;
at least a blue light emitting diode, the red, green and blue light emitting diodes being arranged for providing a white light illuminance;
wherein, each of the red, green, and blue light emitting diodes comprises a substrate, a light emitting diode chip arranged on and electrically connecting with the substrate, and a conical transparent cover arranged on the substrate and surrounding the light emitting diode chip, the cover having an inner surface and a stepped structure formed on the inner surface thereof.

6. The light emitting diode module as claimed in claim 5, wherein the light emitting diodes are arranged in a linear fashion in an order selected from the group consisting of R-G-B, G-R-B-G, G-R-B-R-G, R-G-B-G-R, G-R-B-B-R-G, R-G-R-B-B-G-R, G-R-B-G-G-B-R-G, and G-R-B-B-R-G-G-R-B.

7. The light emitting diode module as claimed in claim 6, wherein a center-to-center distance between two adjacent light emitting diodes is about 9 mm.

8. The light emitting diode module as claimed in claim 5, wherein the light emitting diodes are arranged in a circular fashion.

9. A backlight system, comprising:
a reflecting frame having a reflecting bottom;
an array of light emitting diode modules regularly disposed on the reflecting bottom, the light emitting diode module comprising at least a red light emitting diode, at least a green light emitting diode, at least a blue light emitting diode, the red, green and blue light emitting diodes being arranged for providing a white light illuminance;
wherein, each of the red, green, and blue light emitting diodes comprises a substrate, a light emitting diode chip arranged on and electrically connecting with the substrate, and a conical transparent cover arranged on the substrate and surrounding the light emitting diode chip, the cover having an inner surface and a stepped structure formed on the inner surface thereof.

10. The backlight system as claimed in claim 9, wherein the conical transparent cover comprises a first end defining a first opening and an opposing second end defining a second opening larger than the first opening, a hollow passage is defined in the transparent cover, the first end being connected with the substrate.

11. The backlight system as claimed in claim 9, wherein an outer surface of the cover is conical.

12. The backlight system as claimed in claim 10, wherein the light emitting diode chip is located in a center portion of the first opening.

13. The backlight system as claimed in claim 9, wherein the light emitting diodes are arranged in a linear fashion in an order selected from the group consisting of R-G-B, G-R-B-G, G-R-B-R-G, R-G-B-G-R, G-R-B-B-R-G, R-G-R-B-B-G-R, G-R-B-G-G-B-R-G, and G-R-B-B-R-G-G-R-B.

14. The backlight system as claimed in claim 13, wherein a center-to-center distance between two adjacent light emitting diodes is about 9 mm.

15. The backlight system as claimed in claim 9, wherein the light emitting diodes are arranged in a circular fashion.

16. The backlight system as claimed in claim 9, wherein the reflecting frame further comprises a reflecting sidewall defining an opening, and a diffusing sheet and a prism sheet are located at the opening of the reflecting frame in that order.
